(19) United States
(12) Patent Application Publication
(10) Pub. No.: US 2007/0166587 A1
(43) Pub. Date: Jul. 19, 2007

(54) Fuel cell

(75) Inventors: Satoshi Nagao, Tokyo (JP); Yoshimi Kubo, Tokyo (JP); Tsutomu Yoshitake, Tokyo (JP); Takashi Manako, Tokyo (JP); Hiroshi Kajitani, Tokyo (JP); Hidekazu Kimura, Tokyo (JP); Eiji Akiyama, Tokyo (JP); Yoshinori Watanabe, Tokyo (JP); Yasutaka Kono, Tokyo (JP)

Correspondence Address: HAYES SOLOWAY P.C., 3450 E. SUNRISE DRIVE, SUITE 140, TUCSON, AZ, 85718, US

(73) Assignee: NEC CORPORATION, TOKYO (JP)

(21) Appl. No.: 10/596,277

(22) PCT Filed: Dec. 8, 2004
(86) PCT No.: PCT/JP04/18251

§ 371 Date: Sep. 11, 2006

(30) Foreign Application Priority Data
Dec. 8, 2003 (JP) 2003-408643

(51) Int. Cl. H01M 8/04; H01M 8/24

(52) U.S. Cl. 429/26; 429/32

(57) ABSTRACT

Even when a temperature is lowered, a temperature of a fuel cell is raised, thereby improving the availability. In a fuel cell 1311, a combustion unit 1303 is provided in contact with a unit cell structure 101. In addition, a fuel tank 1309 is provided in contact with a fuel electrode 102 constituting the unit cell structure 101 and supplies a fuel 124 to the fuel electrode 102 directly. A part of the fuel 124 is supplied to the combustion unit 1303 from an combustion fuel discharging exit 1315 provided in the fuel tank 1309 via a combustion fuel supply pipe 1313.

### TECHNICAL FIELD

The present invention relates to a fuel cell.

### BACKGROUND ART

In recent years, with the advent of an information society, as the information volume handled by electronic apparatuses such as a personal computer has been remarkably increased, the power consumption of the electronic apparatuses has been also incremented remarkably. Particularly, portable electronic apparatuses have had the problem of the increase of the power consumption accompanied by the increment of throughput capacity. Currently, in these portable electronic apparatuses, a lithium-ion cell is generally used as a power source, but the energy concentration of the lithium-ion cell is coming close to a theoretical limit. Therefore, so as to increase the continuous-use period of the portable electronic apparatuses, there had been limitation that the power consumption has to be reduced by the control of CPU driving frequency.

Under these circumstances, it is expected that instead of the lithium-ion cell, using a fuel cell having the high energy concentration and heat-exchange effectiveness as a power source of electronic apparatus remarkably improves the lifetime of the portable apparatuses.

The fuel cell is composed of a fuel electrode and an oxidizer electrode (hereinafter, they are also referred to as “catalyst electrodes”), and an electrolyte provided therebetween. A fuel is supplied to the fuel electrode and an oxidizer is supplied to the oxidizer electrode, whereby electricity is generated by the electrochemical reaction. Though hydrogen is generally used as fuel, methanol, which is easily handled and purchased at low price, is also used. A methanol reforming type fuel cell, which generates hydrogen by reforming methanol, and a direct type fuel cell, which directly uses methanol as fuel, have been well developed in recent years.

When the hydrogen is used as the fuel, the reaction at the fuel electrode is given by the following formula (1):
3H₂→6H⁺+6e⁻. (1)

When the methanol is used as fuel, the reaction at the fuel electrode is given by the following formula (2):
CH₃OH+H₂O→6H⁺+CO₂+6e⁻. (2)

Further, in either case, the reaction in the oxidizer electrode is given by the following formula (3):
3/2O₂+6H⁺+6e⁻→3H₂O. (3)

Particularly, in the direct type fuel cell, since a hydrogen ion can be obtained from an aqueous methanol solution, a reforming instrument is not required, whereby the direct type fuel cell is advantageous to apply to portable apparatuses. In addition, the energy density is very high since the aqueous methanol solution is used as fuel.

Here, in general, there is a problem that the fuel cell is less reliable at its startup than other power sources. Especially, since the power generation efficiency of the direct type fuel cell decreases as the temperature drops, if the temperature is low, a desired voltage/current cannot be supplied, whereby the apparatuses may not start up.

To improve the inferiority at the startup of the fuel cell, for example, there is proposed a method for compulsorily raising the temperature up to a predetermined temperature by adding a thermo-electric heater to the fuel cell (Japanese Patent Application Laid-open No. 1-187776: Patent Document 1). Further, there is proposed a method for raising the temperature of the fuel cell up to an optimal operating temperature in a short time, for example, upon starting the fuel cell, the methanol is directly supplied to an air chamber and the methanol is combusted directly by an air electrode, thereby rapidly raising the temperature of the fuel cell (Japanese Patent Application Laid-open No. 5-307970: Patent Document 2).

### DISCLOSURE OF THE INVENTION

### Problems to be Solved by the Invention

However, in the conventional method for adding an electric heater, there were problems that a device to which the electric heater was added was getting larger and a power source for the electric heater was separately required. In addition, in a method for directly combusting methanol by an air electrode, since a pipe for supplying the methanol to the air electrode was needed, when the method was applied to a cell stack including a plurality of unit cells of a fuel cell, the structure thereof became complicated and the device got large.

Meanwhile, when the fuel cell is used for portable apparatuses such as a cellular phone, since the fuel cell is frequently used in the open air, the fuel cell is required to operate under the low-temperature atmosphere of approximately 0° C. Therefore, if the fuel cell is used for portable apparatuses, it is further preferable that there is provided a portable fuel cell that has a convenient mechanism for bringing up outputs to a normal level by raising the temperature of the fuel cell in a short time in spite of a low ambient temperature.

In the view of such circumstances mentioned above, an object of the present invention is to provide a technique capable of improving the availability, even if an outside air temperature not high, by providing a heating unit that raises the temperature of a fuel cell with a convenient mechanism.

### MEANS TO SOLVE THE PROBLEMS

According to the present invention, there is provided a fuel cell comprising a unit cell that includes a solid electrolyte membrane, a fuel electrode and an oxidizer electrode disposed on the solid electrolyte membrane, a heating means that heats the unit cell, and a fuel supplying system that supplies fuel to the fuel electrode, wherein part of the fuel is supplied from the fuel supplying system to the heating means and the heat generated when the fuel supplied to the heating means is combusted by the heating means is conducted to the unit cell, so that the unit cell is heated.

In the fuel cell of the present invention, heat of a heating means is conducted to a unit cell, thereby heating the unit cell. Further, part of fuel supplied to a fuel electrode is supplied to the heating means to be combusted. Therefore, the unit cell can be certainly heated by using the combustion heat of the fuel. Accordingly, the startup characteristic of the cell can be improved by means of a simple mechanism even when a temperature of the outside air in which the fuel cell is used is low.

The fuel cell of the present invention may have one unit cell or a plurality of unit cells.

In the fuel cell of the present invention, the heating means may be provided in contact with the unit cell. Further, in the fuel cell of the present invention, the heating means may have a heating element and a heat conductor provided in contact with the heating element. By this configuration, the heating element may be provided in contact with the unit cell directly or via the heat conductor. Therefore, combustion heat generated in the heating element is efficiently conducted to the unit cell disposed in contact with the heat conductor via the heat conductor provided in contact with the heating element, thereby heating the unit cell. Accordingly, even when the temperature of the environment where the fuel cell is used is low, the unit cell is certainly heated, whereby the startup characteristic of the fuel cell can be improved.

In the fuel cell of the present invention, the heating means may include a heating catalyst for combusting the fuel. By this configuration, the fuel can be certainly combusted by using the catalyst in the heating means. Consequently, the unit cell can be certainly heated.

In the fuel cell of the present invention, the heating element may include the heating catalyst. By this configuration, the unit cell provided in contact with the heating element directly or via the heat conductor can be easily heated.

In the fuel cell of the present invention, liquid fuel may be directly supplied to the fuel electrode. When the liquid fuel is directly supplied, although the startup characteristic is especially required to be improved under a low temperature, that requirement is satisfied in a simple configuration according to the present invention. Even when the liquid fuel is directly supplied to the fuel electrode, a unit cell can be easily heated with the simple configuration. Therefore, the fuel cell demonstrates the satisfactory output characteristic even when the outside air is at low temperature.

The fuel cell of the present invention comprises a plurality of unit cells, a plurality of first electrodes that are provided on one side of a solid electrolyte membrane and a plurality of second electrodes that are provided on the other side of the solid electrolyte membrane, where a second electrode is disposed opposite to a first electrode, wherein the unit cell may be composed of a pair of a first electrode and a second electrode opposed to each other and the solid electrolyte membrane, and the heating means may heat a plurality of the unit cells.

In the fuel cell of the present invention, the plurality of unit cells are configured to share a solid electrolyte membrane. By this configuration, a plurality of unit cells is stably disposed on a plane. In addition, in the fuel cell of the present invention, a plurality of unit cells is heated by the heating means. Therefore, each unit cell constituting the fuel cell can be heated without fail. Accordingly, the good startup characteristic can be secured even when the fuel cell is used under a low temperature.

In the fuel cell of the present invention, the heating means may be provided in contact with the solid electrolyte membrane. When the solid electrolyte membrane is provided in contact with the heating means, the solid electrolyte membrane is heated, thereby a plurality of unit cells sharing the membrane can be simultaneously heated at one dash. Accordingly, even in the fuel cell in which a plurality of unit cells is disposed two-dimensionally, each unit cell can be heated without fail. Therefore, the good startup characteristic can be obtained even when the fuel cell is used at a low temperature.

In the fuel cell of the present invention, the heating means may be provided in contact with a plurality of first electrodes. By this configuration, a plurality of unit cells can be simultaneously heated from one electrode side.

In the fuel cell of the present invention, the heating means may be provided in contact with the oxidizer electrode. Further, in the present invention, the first electrode may be the oxidizer electrode. By this configuration, even in the fuel cell in which the liquid fuel is directly supplied to the fuel electrode, the oxidizer electrode which has low heat capacity and is easily heated is heated faster, thereby heating the entire cell efficiently.

The fuel cell of the present invention may have a fuel recovering means that recovers the fuel having passed through the fuel electrode into the heating means. By this configuration, unused fuel contained in the fuel having passed through the fuel electrode may be used for the combustion in the heating means. Accordingly, the efficiency in the use of the fuel can be improved.

The fuel cell of the present invention may have an oxidizer supplying means that supplies an oxidizer to the heating means. By this configuration, the fuel reaction of the fuel can be further rapidly performed in the heating means. Therefore, the unit cell can be more rapidly heated.

The fuel cell of the present invention may have a cooling water supplying means that supplies cooling water to the heating means. By this configuration, the heating means can be certainly cooled after the unit cell is heated. Therefore, the heating means avoids being overheated, whereby the fuel cell can operate safely.

In the present invention, the fuel cell may further comprise a temperature sensor that measures a heating temperature in the heating means or temperature of the fuel cell, and a control unit that controls supply of the fuel from the fuel supplying system to the heating means based on the temperature measured by the temperature sensor. By this configuration, the heating means can be driven in response to the temperature of the fuel cell. Here, the temperature of the fuel cell may indicate the temperature of the inside, a surface, waste liquid, exhaust air of the fuel cell or outside air around the fuel cell. A certain number of these kinds of temperature may be selected and properly utilized.

In the fuel cell of the present invention, the fuel supply system may include a detachable fuel cartridge. By this configuration, even when the fuel is consumed, the cartridge can be exchanged so that the fuel can be refilled. In the fuel cell of the present invention, the fuel held in the fuel cartridge may be supplied to the heating means.

In the fuel cell of the present invention, the fuel cartridge may have a first chamber that retains first liquid fuel and a second chamber that retains second liquid fuel, wherein the first chamber may have a fuel discharging exit for discharging the first liquid fuel to the heating means and the second chamber may have the fuel discharging exit for discharging the second liquid fuel to a main body of the fuel cell.

Since the fuel cartridge has the first chamber and the second chamber, the fuel cartridge can include high-concentration fuel in addition to low-concentration fuel used for the supply. Since the high-concentration fuel is supplied to the heating means, where the fuel cell can be rapidly heated, the low-temperature startup characteristic is more improved. In the present invention, the fuel cell may have a mixing tank for mixing the first liquid fuel and the second liquid fuel.

Moreover, it is useful as an aspect of the present invention that an arbitrary combination of the above-mentioned components, or components or representation of the present invention is mutually substituted between methods and devices. For example, according to the present invention, an electronic device on which the fuel cell system is mounted can be provided.

### EFFECT OF THE INVENTION

As described above, according to the present invention, even if an outside air temperature is low, the temperature of the fuel cell can be raised and the availability of a device is improved.

### BEST MODE FOR CARRYING OUT THE INVENTION

Hereinafter, embodiments of the present invention will be described with reference to the accompanying drawings. A common reference numeral is given to the same components throughout all drawings and the repetitive explanation will be omitted.

Further, the application of the fuel cell described in embodiments below is not specifically limited. For example, the fuel cell is properly used for small-sized electric apparatuses such as a cellular phone, a portable personal computer including a notebook computer, a PDA (Personal Digital Assistant), a variety of cameras, a navigation system and a portable music reproducing player.

### First Embodiment

FIG. 1 is a schematic diagram showing the configuration of a fuel cell according to this embodiment. A fuel cell 1301 shown in FIG. 1 has a unit cell structure 101 and a combustion unit 1303 provided in contact with the unit cell structure 101. The unit cell structure 101 has a fuel electrode 102, an oxidizer electrode (not shown in FIG. 1) and a solid electrolyte membrane (not shown in FIG. 1) that holds them. In addition, the fuel cell 1301 has a fuel tank 1327 and a pump 1329.

In the fuel cell 1301, fuel 124 contained in the fuel tank 1327 is supplied to the combustion unit 1303 and a unit cell structure 101. In the fuel supplying system at this time, the pump 1329 for controlling the flow of the fuel 124 is provided between the fuel tank 1327 and the combustion unit 1303. Moreover, in the fuel cell shown in FIG. 1, although the pump 1329 is not provided in the fuel supplying line that connects the fuel tank 1327 and the unit cell structure 101, the pump 1329 may be provided as necessary, and this is similarly applied to the other embodiments.

Though not shown, the fuel 124 contained in the fuel tank 1327 may be supplied to the unit cell structure 101 and a part of the fuel 124 supplied from the fuel tank 1327 may be supplied to the combustion unit 1303. Further, the fuel 124 unused at the fuel electrode 102 may be returned to the fuel tank 1327. In addition, the fuel electrode 102 may include the fuel tank 1327 and in this case, a part of the fuel 124 supplied from the fuel electrode 102 is supplied to the combustion unit 1303.

The combustion unit 1303 has a catalyst capable of combusting the fuel 124. When the fuel 124 and a combustion oxidizer are supplied to the combustion unit 1303, the fuel 124 is combusted, thereby generating the combustion heat. And the unit cell structure 101 being in contact with the combustion unit 1303 is heated by the combustion heat. For example, air or oxygen gas may be used as a combustion oxidizer. In addition, a thermometer 1341 for controlling the combustion heat is provided in the combustion unit 1303. Moreover, in the other embodiments, the thermometer 1341 is also provided in the combustion unit 1303.

In the fuel cell 1301, since the combustion unit 1303 that produces heat by the supply of the fuel 124 is in contact with the unit cell structure 101, the unit cell structure 101 can be heated in a simple configuration. Accordingly, the unit cell structure 101 can be easily heated even if the fuel cell 1301 is used at low temperature, whereby the startup characteristic can be improved.

Further, one unit cell structure 101 is shown in FIG. 1, but a plurality of unit cell structures 101 may be serially connected. In addition, the plurality of unit cell structures 101 may be arranged on a planar surface or stacked in a plane direction.

FIG. 2 is a cross-sectional view showing an example of the fuel cell having the configuration shown in FIG. 1. The fuel cell 1311 shown in FIG. 2 has the unit cell structure 101, combustion unit 1303, fuel tank 1309 and a combustion fuel supplying pipe 1313 and pump 1329. The combustion unit 1303 is provided in contact with the unit cell structure 101 and fuel tank 1309. So long as the combustion unit 1303 is in contact with the unit cell structure 101, the combustion unit 1303 may not be in contact with the fuel tank 1309. The thermometer 1341 for measuring the combustion heat is provided in the combustion unit 1303.

In addition, a heat transfer member for transferring the combustion heat generated in the combustion unit 1303 may be provided between the combustion unit 1303 and the unit cell structure 101. By this configuration, the combustion heat can be efficiently transferred to the unit cell structure 101. For example, metals with a high thermal conductivity such as copper, aluminum and titanium can be used as a heat transfer member.

In the fuel cell 1311, the fuel tank 1309 is provided in contact with the fuel electrode 102 constituting the unit cell structure 101, whereby the fuel 124 can be supplied directly to the fuel electrode 102. In the initial state, the fuel 124 with a concentration suitable for supplying it to the unit cell structure 101 is filled in the fuel tank 1309. The detailed configuration of the unit cell structure 101 will be described below.

In this embodiment and a following embodiment, the fuel 124 indicates liquid fuel supplied to the unit cell structure 101 and contains organic solvent and water as fuel components. Organic liquid fuel such as methanol, ethanol, dimethylether, other alcohol or liquid hydrocarbon fuel including cycloparaffin may be used as the fuel component contained in the fuel 124. Hereinafter, methanol is used in the explanation below. As the oxidizer 126, air may be generally used but oxygen gas may be supplied instead.

Further, the concentration of the fuel 124 is properly selected. For example, when the fuel component is methanol, the fuel tank 1309 may contain as the fuel 124 methanol solution with the concentration ranging between more than or equal to 3 volume % and less than or equal to 50 volume %.

It is preferable that the fuel tank 1309 is formed of materials having resistance to fuel components. The fuel tank 1309, for example, can be formed of polypropylene, polyethylene, vinyl chloride or silicon.

A part of the fuel 124 is supplied to a combustion fuel passage 1307 of the combustion unit 1303 through the combustion fuel discharging exit 1315 provided in the fuel tank 1309 via the combustion fuel supplying pipe 1313. The pump 1329 is provided on the combustion fuel supplying pipe 1313, whereby the amount of the fuel 124 supplied to the combustion unit 1303 can be controlled.

A piezoelectric device such as a small-sized piezoelectric motor with very low power consumption, for example, can be used as the pump 1329. A bimorph-type piezoelectric pump, for example, may be used. In addition, a thermometer may be provided in the fuel cell 1311 and a control unit, which is not shown in FIG. 2, may be provided for controlling the operation of the pump 1329 based on the temperature measured by the thermometer.

For a thermometer, those that can measure temperature as an electric signal such as a thermocouple or a thermistor are preferable. The thermometer may be placed in a combustion unit, inside a fuel cell, or on a surface of a fuel cell. Temperature of one of waste solution from a fuel cell, exhaust from a fuel cell or outside air, or a plurality of them may be used.

FIG. 3 is a schematic view showing the configuration of a combustion unit 1303. In FIG. 3, the combustion unit 1303 is a hollow cylinder and in a combustion catalyst retention unit 1305 between an outer wall and an inner wall of the cylinder, a catalyst which combusts the fuel 124 is retained. In addition, one end of the combustion fuel passage 1307 extending in a length direction of the cylinder is communicated with the combustion fuel supplying pipe 1313.

On a surface of the inner wall of the combustion catalyst retention unit 1305, there are holes that lead the fuel 124 from the combustion fuel supplying pipe 1313 to the inside of the combustion catalyst retention unit 1305. It is preferable that the holes are provided all over the inner wall. The holes may be more provided on the side of the oxidizer electrode 108. By this configuration, the oxidizer electrode 108 of the unit cell structure 101 can be preferentially heated. Since the oxidizer electrode 108 has the heat capacity smaller than the fuel electrode 102 and can be easily heated, when the oxidizer electrode 108 is preferentially heated, the whole unit cell structure 101 can be efficiently heated.

A metal mesh, a porous metal sheet and a foaming metal material, for example, can be used as an inner wall material of the combustion catalyst retention unit 1305. The porous metal sheet is only required to have holes passing through the sheet and let the fuel 124 go through. Various forms and thickness may be used without a further limitation. For example, a porous thin metal plate can be used. Further, a metal fiber sheet may be used. A metallic fiber sheet only need be those made of one or more metallic fibers formed in a sheet shape and a non-woven or woven cloth of metallic fiber can be used.

It is preferable that material of the inner wall has corrosion resistance to the fuel 124. The material is preferably metal that acts as a catalyst for the combustion of the fuel 124. Further, as the inner wall material, polymer molecule, ceramic or glass can be used other than metal. Specifically, a chemical fiber sheet or a glass fiber sheet, for example, may be used.

The outer wall of the combustion catalyst retention unit 1305 has air conduction holes leading the combustion oxidizer 126, which combusts the fuel 124, into the inside of the combustion catalyst retention unit 1305. It is preferable that the air conduction holes are provided all over the exposed parts of the outer wall of the combustion catalyst retaining unit 1305. By this configuration, the fuel 124 can be efficiently combusted in the whole combustion catalyst retention unit 1305. An oxidizer 126 supplied to the electrode 108, for example, can be used as a combustion oxidizer 126.

The outer wall of the combustion catalyst retention unit 1305 may be made of porous material. As the porous material, those used for the inner wall of the combustion catalyst retention unit 1305 can be used. In addition, in the fuel cell 1311 shown in FIG. 2, the outer wall of the combustion unit 1303 is in contact with the unit cell structure 101. In this case, the outer wall is made of a material having excellent thermal conductivity. By this configuration, combustion heat generated in the combustion unit 1303 is certainly transferred to the unit cell structure 101, thereby heating the unit cell structure 101.

When a conductive member such as metal is used for the outer wall, the fuel electrode 102 and the oxidizer electrode 108 are insulated against each other to prevent the electrical conduction therebetween. For example, the surface of the combustion unit 1303 can be in contact with the unit cell structure 101 via an insulating sheet having the thermal conductivity.

The combustion catalyst retention unit 1305 may have the combustion catalyst on the surface of a porous support. Steel wool, foaming metal or thin metallic wire sintered body, for example, are used as the support, and they may be filled between the inner wall and the outer wall. In addition, a method for retaining the combustion catalyst on the surface of the support includes a method that the combustion catalyst metal is sprayed onto the surface of the support and then sintered or a method that the combustion catalyst metal is plated on the surface of the support.

In addition, a catalyst capable of combusting fuel components within the fuel 124 is used as the combustion catalyst. Specifically, for example, when the methanol solution is used as the fuel 124, platinum or an alloy of platinum and ruthenium is exemplified as the combustion catalyst.

The porous supports may consist of the combustion catalyst metal. By this configuration, the fuel catalyst retention unit 1305 can be simply configured.

Further, in FIG. 3, though the combustion unit 1303 is hollow, the combustion unit 1303 can be solid. FIG. 4 shows a solid combustion unit 1303. In this case, the entire content of the combustion unit 1303 can be filled with the combustion catalyst retention unit 1305. In this configuration, the fuel 124 having passed through the combustion fuel supplying pipe 1313 is also supplied from one end of the combustion unit 1303 to the combustion catalyst retention unit 1305.

In addition, so long as the combustion heat can be transferred to the unit cell structure 101, the shape of the combustion unit 1303 is not limited to a cylindrical shape shown in FIGS. 3 and 4. FIG. 5 shows another configuration of the combustion unit 1303. Since the combustion unit 1303 shown in FIG. 5 has a flattened surface on the sides, it better contacts the unit cell structure 101. Therefore, the heat is more efficiently transferred from the combustion unit 1303 to the unit cell structure 101.

Referring back to FIG. 2, the configuration of the unit cell structure 101 will be described. The unit cell structure 101 includes the fuel electrode 102, the oxidizer electrode 108 and a solid electrolyte membrane 114. As described above, the fuel 124 is supplied to the fuel electrode 102 of the unit cell structure 101. The oxidizer 126 is supplied to the oxidizer electrode 108.

The oxidizer 126 to the oxidizer electrode 108 may be supplied by natural suction of air or forcible suction by a fan (not shown). The oxidizer may also be supplied by means of a piezoelectric pump. When the piezoelectric pump is used, the supply amount of the oxidizer 126 from the piezoelectric pump can be favorably controlled by changing an inverter, a frequency or a voltage of the inverter. When the inverter or the frequency of the inverter is changed, the number of discharges of the pump per unit time can be changed, and when the voltage is changed, a discharge amount per one discharge is changed along with the change of displacement of the piezoelectric device.

In the unit cell structure 101 shown in FIG. 2, a substrate 104 and a substrate 110 also act as a gas diffusion layer and a collecting electrode. A fuel electrode terminal and an oxidizer electrode terminal can be provided on the substrate 104 and substrate 110, respectively (not shown). A metal mesh, a porous metal sheet or foaming metal material, for example, may be used for the substrates 104 and 110. By this configuration, even if a bulk metallic collecting member is not provided, electric power can be efficiently collected.

The solid electrolyte membrane 114 serves as a separation of the fuel electrode 102 and the oxidizer 108, and prevents movement of hydrogen ions therebetween. As the result, it is preferable that the solid electrolyte membrane 114 has a high conductivity for hydrogen ions. In addition, it is preferable that the membrane has a chemical stability and a high mechanical strength.

As material for the solid electrolyte membrane 114, organic polymer molecules having polar groups such as strong acid groups including sulfonic groups, phosphoric groups, phosphonic groups and phosphinic groups, or weak acid groups including carboxyl groups are preferably used. The organic polymer molecules include: polymers of the aromatic class such as sulfonate poly (4-phenoxybenzoyl-1,4-phenylene) and alkyl sulfonate poly benzimidazole group; copolymer such as polystyrene sulfonate copolymer, polyvinyl sulfonate copolymer, crosslink alkylsulfonate derivative and fluorine-containing polymer composed of fluorine resin backbone and sulfonic acid; copolymer obtained by copolymerizing acrylamides such as acrylamide-2-methylpropane sulfonic acid with acrylates such as n-butylmethacrylate; sulfonate-group-containing perfluorocarbon (NAFION manufactured by Dupont and ACIPLEX manufactured by Asahi Kasei Corporation); and carboxyl-group-containing perfluorocarbon (FLEMION S MEMBRANE (manufactured by Asahi Glass Co., LTD)). When the polymer of the aromatic class such as sulfonate poly (4-phenoxy benzoyl-1,4-phenylene) and alkyl sulfonate poly benzimidazole group is selected, the permeation of organic liquid fuel can be suppressed, whereby the reduction of the cell efficiency caused by the crossover can be suppressed.

In the fuel electrode 102 and the oxidizer electrode 108, a catalyst layer 106 of the fuel electrode and a catalyst layer 112 of the oxidizer electrode including carbon particles and solid electrolyte particles and supporting catalysts may be formed on the substrate 104 and substrate 110, respectively. Platinum or an alloy of platinum and ruthenium is exemplified as the catalyst. Either the same catalysts or different catalysts may be used in the fuel electrode 102 and oxidizer electrode 108.

A water repellent treatment may be implemented on the surfaces of substrates 104 and 110. As described above, in the case where methanol is used as the fuel 124, carbon dioxide is generated in the fuel electrode 102. If the carbon dioxide generated in the fuel electrode 102 stays in the vicinity of the fuel electrode 102, the supply of the fuel 124 to the fuel electrode 102 is blocked, whereby the power generation efficiency is lowered. Here, it is preferable that the surface treatment by means of a hydrophilic coating material or a hydrophobic coating material is performed on a surface of the substrate 104. The surface treatment by means of the hydrophilic coating material improves the fluidity of the fuel 124 on the surface of the substrate 104. This enables carbon dioxide bubbles to easily move with the fuel 124. The surface treatment by means of a hydrophobic coating material reduces the attachment of moisture that causes bubbles on the surface of the substrate 104. Accordingly, the formation of bubbles can be reduced on the surface of the substrate 104.

The hydrophilic coating materials include, for example, titanium oxide and silicon oxide. On the other hand, the hydrophobic coating materials include polytetrafluoroethylene and silane.

As described above, the unit cell structure 101 is obtained. The unit cell structure 101 is disposed in contact with the combustion unit 1303 as shown in FIG. 2, so that the combustion heat generated in the combustion unit 1303 can be transferred to the unit cell structure 101.

Next, a method for using a fuel cell 1311 will be described. When the fuel cell 1311 is used over a temperature of, for example, approximately 25° C., where the startup characteristic of the fuel cell 1311 is secured, the pump 1329 is not driven. In this case, the fuel 124 in the fuel tank 1309 is supplied only to the fuel electrode 102. When the fuel cell 1311 is used at a temperature at which the startup characteristic is favorable, the fuel 124 is selectively supplied only to the fuel electrode 102 so that the waste of the fuel electrode 102 is reduced, thereby operating the fuel cell 1311 stably.

On the other hand, when the fuel cell 1311 is used at a low temperature, the pump 1329 is driven. By this configuration, part of the fuel 124 in the fuel tank 1309 is supplied to the combustion unit 1303. In addition, the oxidizer 126 is externally supplied to the combustion unit 1303. Then, the fuel 124 is combusted by the function of the combustion catalyst retained in the support in the combustion catalyst retention unit 1305 so that the combustion heat is generated. This combustion heat is transferred to the unit cell structure 101, thereby raising the temperature of the unit cell structure 101. Therefore, by a simple configuration, the startup characteristic of the unit cell structure 101 can be improved at a low temperature.

As described above, the fuel cell 1311 can exert an excellent startup characteristic even when it is used under the condition that the outside air has a low temperature. The “low temperature” described above indicates a temperature condition under which a cell voltage of the fuel cell 1311 is not sufficiently obtained. More specifically, the startup characteristic can be improved, for example, at a low temperature of 0° C. to 20° C.

The temperature described above is just an example when the fuel cell 1311 is used. It can be properly controlled whether or not the fuel 124 is supplied to the combustion unit 1303 and how much the fuel 124 is supplied. In addition, the fuel cell of this embodiment can have a control unit that controls the operation of the pump 1329 based on a temperature measured by a thermometer 1341.

FIG. 6 is a plan view showing another example of the fuel cell having the configuration shown in FIG. 1. FIG. 6 shows the configuration of the fuel cell in which a plurality of unit cell structures 101 is disposed two-dimensionally. In addition, FIG. 6 is a view of the fuel cell from the oxidizer electrode 108 of the unit cell structure 101. The fuel cell shown in FIG. 6 includes a fuel cell body 1109 and a fuel cartridge 1103.

The fuel cell body 1109 includes the plurality of unit cell structures 101 disposed two-dimensionally, a fuel container 811, partition plates 853, a fuel discharging pipe 1111, a combustion fuel supplying pipe 1343, a fuel discharge pipe 1337, a pump 1117, a flow control valve 1331, a connector 1123 and the thermometer 1341.

FIG. 7 is a cross-sectional view taken along line A-A′ of FIG. 6. The fuel electrode 102 is provided on one side of a solid electrolyte membrane 114 and the oxidizer electrode 108 is provided on the other side. The combustion unit 1303 is in contact with an end face of the solid electrolyte membrane 114 via a heat transfer plate 1317. The fuel container 811 is in contact with the fuel electrode 102.

Referring back to FIG. 6, the fuel cartridge 1103 is detachable from the fuel cell body 1109 by means of the connector 1123. In an initial state, the fuel cartridge 1103 is filled with the fuel 124 of a certain concentration suitable for the unit cell structure 101. The concentration of the fuel 124 may be properly selected like the fuel cell 1311 shown in FIG. 2.

In addition, it is preferable that the fuel cartridge 1103 is made of material having resistance to the fuel components. For example, the fuel cartridge 1103 can be formed of polypropylene, polyethylene, vinyl chloride or silicon.

The fuel 124 is supplied to the fuel container 811 via the fuel discharging pipe 1111. The fuel 124 in the fuel container 811 flows along a plurality of partition plates 853 provided in the fuel container 811 and is sequentially supplied to the plurality of unit cell structures 101.

A pump 1117 is provided to the fuel discharging pipe 1111. In addition, the combustion fuel supplying pipe 1343 branches out on the downstream side from the pump 1117 of the fuel discharging pipe 1111, that is, on the side of the fuel container 811, whereby part of the fuel 124 is supplied to the combustion unit 1303 from the combustion fuel supplying pipe 1343. The flow control valve 1331 is provided at a point of the fuel discharging pipe 1111 where the combustion fuel supplying pipe 1343 branches off, thereby controlling the amount of the fuel 124 supplied to the combustion unit 1303.

As the pump 1117, a piezoelectric device such as a small-sized piezoelectric motor with very low power consumption can be used as the fuel cell 1311 shown in FIG. 2. In addition, though not shown in FIG. 6, the fuel cell of this embodiment may have a control unit that controls the operation of the pump 1117 and the flow control valve 1331 based on a temperature measured by a thermometer 1341.

Catalysts that combust the fuel 124 are held in the combustion unit 1303. One end of the combustion unit 1303 is connected to the combustion fuel supplying pipe 1343. The other end of the combustion unit 1303 is connected to the combustion fuel discharge pipe 1337 and remaining fuel having passed through the combustion unit 1303 is led into the fuel container 811. Further, the remaining fuel led into the fuel container 811 is, for example, input to the fuel container 811 with carbon dioxide generated by the combustion where the remaining fuel has benn vaporized by the combustion heat of the combustion unit 1303.

As described in FIG. 7, in the fuel cell shown in FIG. 6, a plurality of electrodes and oxidizers are provided on each side of one sheet of the solid electrolyte membrane 114, and a plurality of unit cell structures 101 sharing the solid electrolyte membrane 114 are formed on the same plane. And the combustion heat generated in the combustion unit 1303 can be transferred to each unit cell structure 101 from the solid electrolyte membrane 114 since the combustion unit 1303 is in contact with an end face of the solid electrolyte membrane 114 via the heat transfer plate 1317. Therefore, the unit cell structures 101 sharing the electrolyte membrane 114 can be heated at the same time. Accordingly, the startup characteristic of the fuel cell can be improved even if the outside air has a low temperature.

Further, even in the fuel cell having the plurality of unit cell structures 101, a heat transfer member can be provided between the combustion unit 1303 and the fuel container 811.

In the fuel cell according to this embodiment, fuel components that have not been used for a cell reaction in the fuel 124 having passed through the unit cell structure 101 may be supplied to the combustion unit 1303. FIG. 8 is a schematic view showing the configuration of this fuel cell. The fuel cell shown in FIG. 8 connects the fuel electrode 102 of the unit cell structure 101 with the combustion unit 1303 in the fuel cell 1301 shown in FIG. 1. By this configuration, since the remaining fuel discharged from the fuel electrode 102 of the unit cell structure 101 can be supplied to the combustion unit 1303, thereby improving the efficiency of the fuel. Therefore, the fuel cell can be stably operated for a long period. Further, a pump 1329 can be provided at a passing path of the fuel between the unit cell structure 101 and the combustion unit 1303.

In addition, the fuel cell shown in FIG. 8 can lead the fuel 124 supplied to the combustion unit 1303 to the fuel electrode 102 of the unit cell structure 101 after the fuel 124 passed the combustion 1303. By this configuration, the remaining fuel discharged to the outside can be further reduced. As the result, the fuel can be efficiently used. Further, the remaining fuel having passed through the combustion unit 1303 may be supplied to the unit cell structure 101 in a vaporized state with gases generated by the combustion of the fuel 124.

FIG. 9 is a schematic view showing another configuration of the fuel cell of this embodiment. In the fuel cell shown in FIG. 9, a fuel supplying system has a fuel tank 1327, a pump 1329 which controls the flow of the fuel 124, and the flow control valve 1331 which is provided at the downstream from the pump 1329 and controls the supply amount of the fuel to the combustion unit 1303 and the unit cell structure 101.

Even in this configuration, the amount of the fuel 124 supplied to the combustion unit 1303 can be also controlled by the flow control valve 1331. In addition, the remaining fuel having passed through the combustion unit 1303 is led into the unit cell structure 101 from the fuel supplying system that connects the flow control valve 1331 and the unit cell structure 101.

### Second Embodiment

In a second embodiment, though not shown, a combustion unit 1303 is provided at a side opposite to a fuel electrode 102 of the fuel cell 1301 (shown in FIG. 1) described in the first embodiment, thereby heating an oxidizer electrode not shown in FIG. 1. In addition, in the second embodiment, a fuel cell 1311 (shown in FIG. 2) described in the first embodiment heats the entire configuration member of a unit cell structure 101. Here, in general, when liquid fuel is supplied to the fuel electrode 102, an oxidizer 126 has a smaller heat capacity than the fuel 124. Therefore, heating processes of the fuel electrode 102 and an oxidizer electrode 108 can be different and the oxidizer electrode 108 may be heated more easily. Here, this embodiment shows a way to efficiently heat the unit cell structure 101.

FIGS. 10 and 11 show the configuration of the fuel cell of this embodiment. FIG. 11 is a cross-sectional view taken along line A-A′ shown in FIG. 10.

In the fuel cell 1345 shown in FIGS. 10 and 11, a heat transfer plate 1317 is provided in contact with a peripheral portion of a substrate 110 and a thermometer 1341 is provided on the heat transfer plate 1317. In addition, the tubular combustion unit 1303 zigzags on a surface of the oxidizer electrode 108 in contact with the heat transfer plate 1317.

The oxidizer 126 is supplied to the oxidizer electrode 108 through the part of the surface of the substrate 110 that is not covered by the heat transfer plate 1317 and the combustion unit 1303. Further, as described in the first embodiment, the substrate 110 also serves both as a collecting electrode and a gas diffusion layer. In addition, the substrate 110 has holes to pass the oxidizer 126 required for a cell reaction.

It is preferable that material having a high thermal conductivity is used for the heat transfer plate 1317. For example, a copper plate, an aluminum plate and a titanium plate can be used. The combustion unit 1303 can be configured as shown in the first embodiment.

In a fuel cell 1345 of this embodiment, since the heat transfer plate 1317 is provided between the combustion unit 1303 and the substrate 110, combustion heat generated in the combustion unit 1303 can be efficiently transferred to the oxidizer 108 and the oxidizer 108 can be selectively or intensively heated. The oxidizer electrode 108 itself is heated by heat generated by the chemical reaction and is rapidly heated also by combustion heat generated in the combustion unit 1303. Therefore, the heat is transferred to the entire unit cell structure 101, thereby efficiently heating the whole unit cell structure 101. Therefore, the startup characteristic of the fuel cell can be further improved under a low temperature.

FIG. 12 is a plan view showing another configuration of the fuel cell of this embodiment. In the fuel cell shown in FIG. 12, a plurality of unit cell structures 101 are two-dimensionally disposed as the fuel cell shown in FIG. 6.

In the fuel cell shown in FIG. 12, the combustion unit 1303 is in contact directly with the oxidizer electrode 108 (not shown in FIG. 12) of each unit cell structure 101. Therefore, the unit cell structure 101 can be efficiently heated. Further, in the configuration shown in FIG. 12, a surface of the combustion unit 1303 contacting with the unit cell structure 101 is made of an insulating member so that the unit cell structures 101 are not electrically connected to each other via the combustion unit 1303. An insulating sheet having an excellent thermal conductivity, for example, may be used as the insulating member. Material like silicon rubber or epoxy resin to which a thermal conductive filler is added, for example, may be used for the insulating sheet. As the thermal conductive filler, aluminum, for example, may be used.

The configuration in which the oxidizer electrode of the unit cell structure 101 is directly heated can be applied to FIGS. 1, 8 and 9, and other embodiments described below.

### Third Embodiment

In the fuel cell according to the first or second embodiment, a fuel supplying system may have a fuel container retaining a fuel 124 and a high-concentration fuel container retaining a liquid fuel having a concentration higher than that of the fuel 124 supplied to a unit cell structure 101.

FIG. 13 is a schematic view showing the configuration of the fuel cell according to this embodiment. In the fuel cell shown in FIG. 13, a fuel tank 1327 consists of a low-concentration fuel tank 1333 and a high-concentration fuel tank 1335. In an initial state, the low-concentration fuel tank 1333 is filled with the low-concentration fuel having a concentration suitable for the unit cell structure 101 and the high-concentration fuel tank 1335 is filled with the high-concentration fuel 725 having a fuel component concentration higher than the liquid in the low-concentration fuel tank 1333. Further, in the fuel cell shown in FIGS. 13 and 14 in the third embodiment, although a pump 1329 is not provided on a fuel supplying system that connects the fuel tank 1327 and the unit cell structure 101, the pump 1329 may be provided if necessary. Further, the fuel 124 not used in a fuel electrode 102 may be returned to the fuel tank 1327.

The low-concentration fuel and the high-concentration fuel are properly selected. For example, when the fuel component is methanol, the low-concentration fuel can contain a methanol solution having a concentration of 50 volume % or less, or water. The high-concentration fuel tank 1335 can contain a methanol solution or methanol having a concentration higher than that of the fuel 124.

The high-concentration fuel 725 in the high-concentration fuel tank 1335 is supplied to the low-concentration fuel tank 1333 by the pump 1329. And in the unit cell structure 101, the fuel 124 adjusted to a predetermined fuel component concentration at the low-concentration fuel tank 1333 is supplied to the unit cell structure 101. In FIG. 13, a pump 1329 for supplying the fuel 124 from the low-concentration fuel tank 1333 to the unit cell structure 101 can be provided.

In addition, part of the high-concentration fuel 725 in the high-concentration fuel tank 1335 is supplied to a combustion unit 1303 by the pump 1329. The high-concentration fuel 725 is supplied to the combustion unit 1303, thereby heating the unit cell structure 101 more rapidly.

FIG. 14 shows an example of the fuel cell having the configuration shown in FIG. 13. A fuel cell 1349 shown in FIG. 14 has a basic structure similar to the fuel cell shown in FIG. 2. A mixing tank 1319 is provided instead of the fuel tank 1309 in contact with a substrate 104. The fuel cell 1349 also has a high-concentration fuel tank 1321. A high-concentration fuel supplying pipe 1323 supplying the high-concentration fuel 725 to the mixing tank 1319 from the high-concentration fuel tank 1321 is provided. The amount of the high-concentration fuel 725 flowing through the high-concentration fuel supplying pipe 1323 can be controlled by the pump 1329.

In addition, in the fuel cell 1349, the combustion fuel supplying pipe 1313 connects the high-concentration fuel tank 1321 and a combustion fuel passage 1307. Therefore, the high-concentration fuel 725 having a high-concentration fuel component concentration can be directly supplied from the high-concentration fuel tank 1321 to the combustion unit 1303.

In the fuel cell 1349, since the high-concentration fuel 725 can be supplied to the combustion unit 1303, the combustion reaction can be efficiently generated in the combustion unit 1303. Accordingly, the unit cell structure 101 can be more rapidly heated and the startup characteristic at a low temperature can be further improved.

In addition, FIG. 15 shows the fuel cell in which a plurality of unit cell structures 101 is disposed two-dimensionally. In the fuel cell shown in FIG. 15, the combustion unit 1303 is provided in contact with a solid electrolyte membrane 114 (not shown in FIG. 15) constituting the unit cell structure 101 similar to the fuel cell shown in FIG. 6. As shown in FIG. 15, in the fuel cell having the plurality of unit cell structures 101, the combustion unit 1303 is in contact with the solid electrolyte membrane 114 constituting the unit cell structure 101, thereby heating the plurality of unit cell structures 101 sharing the solid electrolyte membrane 114 at the same time. In addition, since the high-concentration fuel 725 is supplied to the combustion unit 1303, the unit cell structures 101 can be efficiently heated.

In addition, a fuel cartridge 1103 comprises a high-concentration fuel tank 1105 and a mixing tank 1107 that are detachably connected by means of a joint (not shown). The high-concentration fuel tank 1105 and mixing tank 1107 in a connected state are connected to or disconnected from a fuel cell body 1109. In an initial state, the mixing tank 1107 is filled with a low-concentration fuel having a concentration suitable for the fuel cell body 1109 and the high-concentration fuel tank 1105 is filled with the high-concentration fuel 725 having a fuel component concentration higher than the liquid in the mixing tank 1107.

In addition, the fuel having circulated the plurality unit cell structures 101 is returned to the mixing tank 1107 via a fuel recovering pipe 1113. By this configuration, the fuel 124 not consumed in the unit cell structure 101 can be recovered suitably as recovery fuel so as to be reused.

Further, the fuel cell shown in FIG. 15 may have a control unit (not shown). In this case, for example, a concentration of the recovery fuel 1155 recovered from the fuel recovering pipe 1113 is measured by means of a concentration meter (not shown), and the supply of the fuel from the high-concentration fuel tank 1105 to the mixing tank 1107 may be controlled in reference to the measured concentration. Concentrations of the fuel components in the mixing tank 1107 may be measured by a concentration meter (not shown) so that the control unit can control the amount of the high-concentration fuel 725 supplied to the mixing tank 1107 in reference to the measured concentration.

Further, in this embodiment, fuel components that were not used for a cell reaction and have passed the unit cell structure 101 may be supplied to the combustion unit 1303. FIG. 16 is a schematic view showing the configuration of the fuel cell. In the fuel cell shown in FIG. 16, a fuel electrode 102 of the unit cell structure 101 is connected to the combustion unit 1303 as shown in FIG. 13.

FIG. 17 shows an example of the fuel cell having the configuration shown in FIG. 16. In FIG. 17, in the fuel cell 1349 shown in FIG. 14, remaining fuel having passed through the substrate 104 is infused into the combustion fuel passage 1307 from the fuel recovering pipe 1347.

In addition, FIG. 18 is a schematic view showing another configuration of the fuel cell of this embodiment. In the fuel cell shown in FIG. 18, the fuel supplying system has the pump 1329 controlling the flow of the high-concentration fuel 725 discharged from the high-concentration fuel tank 1335 and a flow control valve 1331, which is placed on a downstream side from the pump 1329 and controls the supply amount of the high-concentration fuel 725 to the combustion unit 1303 and a low-concentration fuel tank 1333.

The amount of the high-concentration fuel 725 supplied to the combustion unit 1303 or the low-concentration fuel tank 1333 can be controlled by the flow control valve. In addition, the fuel components not used for the fuel reaction having passed through the unit cell structure 101 is supplied to the combustion unit 1303.

FIG. 19 is a schematic view showing another example of a fuel supplying system of the fuel cell of this embodiment. In addition, FIG. 20 shows an example of the fuel cell having the fuel supplying system shown in FIG. 19.

The fuel cell shown in FIG. 19 has a path through which the fuel is supplied from the high-concentration fuel tank 1333 to the unit cell structure 101 and a path through which fuel left in the unit cell structure 101 is returned to the low-concentration fuel tank 1333. The fuel cell has paths that supply the high-concentration fuel 725 in the high-concentration fuel tank 1335 to the low-concentration fuel tank 1333 and the combustion unit 1303. The fuel cell has a path that leads the fuel having passed through the unit cell structure 101 to the combustion unit 1303. The supply of the high-concentration fuel 725 or the remaining fuel to the combustion unit 1303 can be switched by the flow control valve 1331 and each flow can be controlled by the pump 1329.

In the fuel cell shown in FIG. 19, since the remaining fuel having passed through the unit cell structure 101 can be recovered to the low-concentration fuel tank 1333 so as to be reused, the waste of the fuel components can be reduced, so that the remaining fuel can be efficiently used. Even when the fuel components in the low-concentration fuel tank 1333 are diluted with the recovered fuel, since the high-concentration fuel 725 can be supplied from the high-concentration fuel tank 1335, the fuel 124 having a predetermined concentration can be stably supplied to the unit cell structure 101 for a long period.

In addition, in the fuel cell shown in FIG. 19, the remaining fuel or the high-concentration fuel 725 having passed through the unit cell structure 101 is properly selected so as to be supplied to the combustion unit 1303. Therefore, when the fuel cell is activated at a low temperature, the high-concentration fuel 725 is supplied to the combustion unit 1303, thereby rapidly heating the unit cell structure 101 being in contact with the combustion 1303. And when the unit cell structure 101 is warmed to some extent, the remaining fuel is supplied to the combustion unit 1303 by controlling the flow control valve 1331, thereby using the fuel components more efficiently.

### Fourth Embodiment

A fuel cell having a low-concentration fuel tank 1333 and a high-concentration fuel tank 1335 according to the third embodiment may have a mixing tank that mixes a low-concentration fuel in the low-concentration fuel tank 1333 and a high-concentration fuel 725 in the high-concentration fuel tank 1335.

FIG. 21 is a schematic view showing a fuel supplying system of the fuel cell of this embodiment. In the fuel cell shown in FIG. 21, a low-concentration fuel 1149 in the low-concentration fuel tank 1333 and the high-concentration fuel 725 in the high-concentration fuel tank 1335 are infused into the mixing tank 1339. In the mixing tank 1339, the fuel 124 adjusted to a concentration suitable for a unit cell structure 101 is supplied to the unit cell structure 101 from the mixing tank 1339.

In addition, part of the high-concentration fuel 725 discharged from the high-concentration fuel tank 1335 can be supplied to the combustion unit 1303 provided in contact with the unit cell structure 101. Here, a pump 1329 is provided in a supplying system of the high-concentration fuel 725, and the high-concentration fuel 725 with a predetermined amount can be supplied to the mixing tank 1339 and combustion unit 1303 by a flow control valve 1331 provided at a downstream point from the pump 1329.

By this configuration, a concentration of the fuel 124 supplied to the unit cell structure 101 can be more precisely controlled. Therefore, a cell reaction in the unit cell structure 101 can be more stably generated. In addition, since the high-concentration fuel 725 is supplied to the combustion unit 1303, the unit cell structure 101 can be rapidly heated in a short time. Accordingly, the startup characteristic of the fuel cell at the low temperature can be improved.

FIG. 22 shows another configuration of the fuel cell of this embodiment. The basic configuration of the fuel cell shown in FIG. 22 is the same as that of the fuel cell shown in FIG. 21, but the fuel cell in FIG. 22 further comprises a path that recovers remaining fuel having passed through a fuel electrode 102 of the unit cell structure 101 to the mixing tank 1339 and a path that recovers remaining fuel having passed through the combustion unit 1303 to the mixing tank 1339.

The fuel components can be more efficiently used by providing these recovery paths. Therefore, the startup characteristic of the fuel cell can be improved and the fuel cell can stably operate for a long period.

### Fifth Embodiment

In the fuel cell according to the embodiment described above, a cooling water infusion path for infusing cooling water into a combustion unit 1303 can be provided. Here, the configuration of the fuel cell shown in FIG. 23 will be described as an example.

FIG. 23 is a schematic view showing the configuration of the fuel cell according to this embodiment. The fuel cell shown in FIG. 23 further comprises a cooling water tank 1351 compared with the fuel cell shown in FIG. 22. Cooling water 1353 in the cooling water tank 1351 can be supplied to the combustion unit 1303 by means of a pump 1329.

When the fuel cell shown in FIG. 23 is activated at a low temperature, a high-concentration fuel 725 is supplied to the combustion unit 1303, thereby generating combustion heat. The combustion heat is transferred to a unit cell structure 101 thereby heating the unit cell structure 101. In order to prevent the unit cell structure 101 from being overheated by the combustion heat generated by the high-concentration fuel 725, the supply of the high-concentration fuel 725 to the combustion unit 1303 is stopped and the cooling water 1353 is supplied from the cooling water tank 1351 to the combustion unit 1303 by detecting that the unit cell structure 101 is heated up to a predetermined temperature by means of a thermometer 1341 provided in the unit cell structure 101. In this way, the combustion unit 1303 can be rapidly cooled. Therefore, heating the unit cell structure 101 is suppressed, whereby the fuel cell can more stably operate.

Further, in the fuel cell having the low-concentration fuel tank 1333 and high-concentration fuel tank 1335, even though the fuel 124 is supplied to the combustion unit 1303 from the low-concentration fuel tank 1333 instead of the cooling water, the generation of the combustion heat can be suppressed. In this case, the high-concentration fuel 725 is supplied to the combustion unit 1303 at the startup and then the fuel 124 is supplied when the unit cell structure 101 is heated to some extent. By this configuration, the fuel components can be efficiently used.

### Sixth Embodiment

In the fuel cell according the embodiments described above, an oxidizer supplying path that actively supplies the combustion oxidizer to a combustion unit 1303 may be further provided. In the description below, the configuration of the fuel cell shown in FIG. 1 will be used as an example.

FIG. 24 is a schematic view showing the configuration of the fuel cell according to this embodiment. The fuel cell shown in FIG. 24 further has an oxidizer retention unit 1355 in the fuel cell 1301 compared with FIG. 1 and the oxidizer 1357 retained in the oxidizer retention unit 1355 can be supplied to the combustion unit 1303. For example, a line that sends compressed air to the combustion unit 1303 is provided or the oxidizer is supplied to the combustion unit 1303 by means of a fan, so that the combustion reaction speed in the combustion unit 1303 can be improved, whereby the startup characteristic of the fuel cell at a low temperature can be further improved. Further, in the fuel cell shown in FIG. 24, although a pump 1329 is not provided in a fuel supplying system that connects the a fuel tank 1327 with a unit cell structure 101, the pump 1329 may be provided if necessary. Further, the fuel 124 not used in a fuel electrode 102 may be recovered to the fuel tank 1327.

In the fuel cell shown in FIG. 24, the fuel 124 is infused into the combustion unit 1303 and the oxidizer 1357 can be actively supplied to the combustion unit 1303. Therefore, in the combustion unit 1303, the combustion reaction can be generated more surely than when oxygen in the air is supplied to the combustion unit 1303. Therefore, the startup characteristic of the fuel cell at a low temperature can be further improved.

As described above, the invention has been described based on the embodiments of the present invention. These embodiments are the examples. A variety of modified examples that can be performed in combination of components or treatment processes thereof, and modified examples that are involved within the scope of the invention are understood by those skilled in the art.

### BRIEF DESCRIPTION OF THE DRAWINGS

FIG. 1 is a schematic view showing a configuration of a fuel cell according to this embodiment.

FIG. 2 is a cross-sectional view showing an example of the fuel cell having the configuration shown in FIG. 1.

FIG. 3 is a schematic view showing the configuration of a combustion unit in the fuel cell according to this embodiment.

FIG. 4 is a schematic view showing the configuration of a combustion unit in the fuel cell according to this embodiment.

FIG. 5 is a schematic view showing the configuration a combustion unit in the fuel cell according to this embodiment.

FIG. 6 is a plan view showing an example of the fuel cell having the configuration shown in FIG. 1.

FIG. 7 is a cross-sectional view of the fuel cell taken along line A-A′ shown in FIG. 6.

FIG. 8 is a schematic view showing the configuration of the fuel cell according to this embodiment.

FIG. 9 is a schematic view showing the configuration of the fuel cell according to this embodiment.

FIG. 10 is a cross-sectional view showing an example of the fuel cell according to this embodiment.

FIG. 11 is a cross-sectional view taken along line A-A′ shown in FIG. 10.

FIG. 12 is a plan view showing the fuel cell according to this embodiment.

FIG. 13 is a schematic view showing the configuration of the fuel cell according to this embodiment.

FIG. 14 is a cross-sectional view showing an example of the fuel cell having the configuration shown in FIG. 13.

FIG. 15 is a plan view showing an example of the fuel cell having the configuration shown in FIG. 3.

FIG. 16 is a schematic view showing the configuration of the fuel cell according to this embodiment.

FIG. 17 is a cross-sectional view showing an example of the fuel cell having the configuration shown in FIG. 16.

FIG. 18 is a schematic view showing the configuration of the fuel cell according to this embodiment.

FIG. 19 is a schematic view showing the configuration of the fuel cell according to this embodiment.

FIG. 20 is a cross-sectional view showing an example of the configuration of the fuel cell having the configuration shown in FIG. 19.

FIG. 21 is a schematic view showing the configuration of the fuel cell according to this embodiment.

FIG. 22 is a schematic view of the configuration of the fuel cell according to this embodiment.

FIG. 23 is a schematic view showing the configuration of the fuel cell according to this embodiment.

FIG. 24 is a schematic view showing the configuration of the fuel cell according to this embodiment.

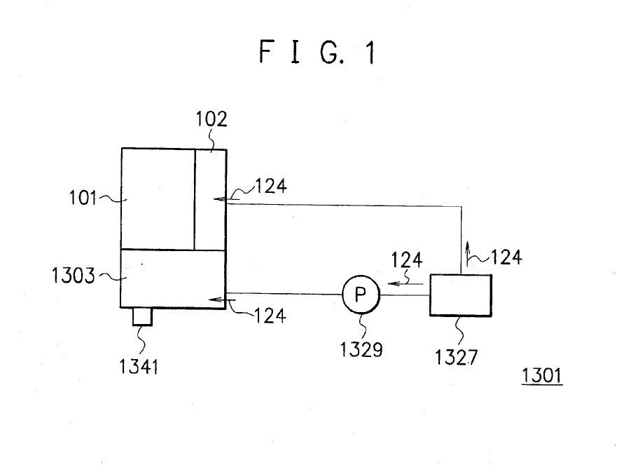

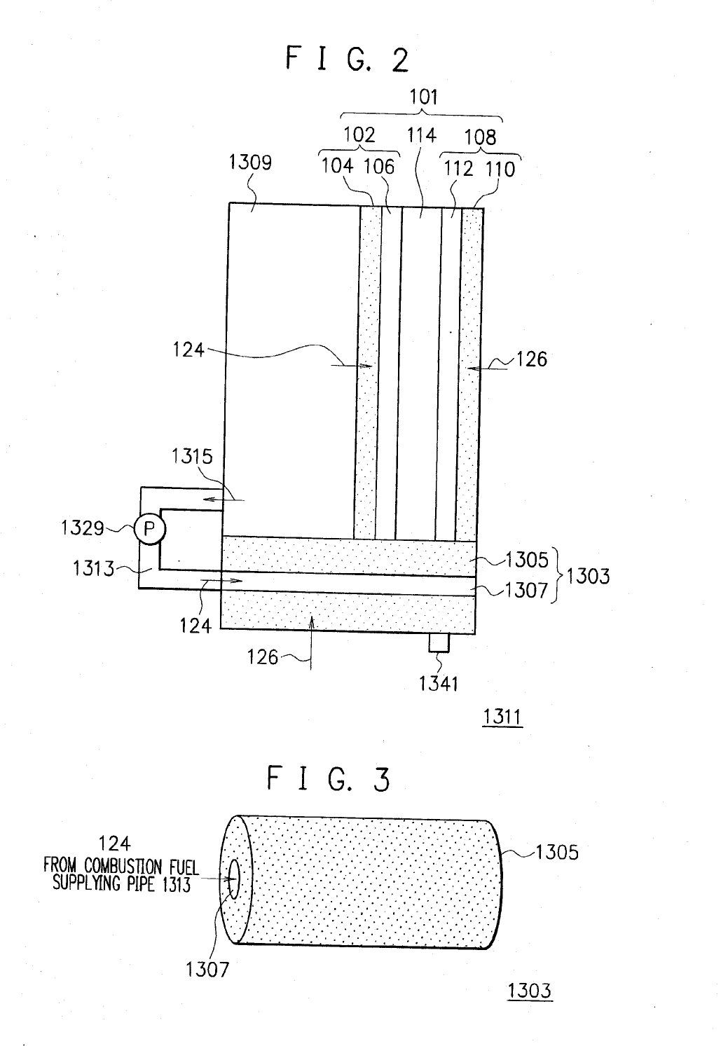

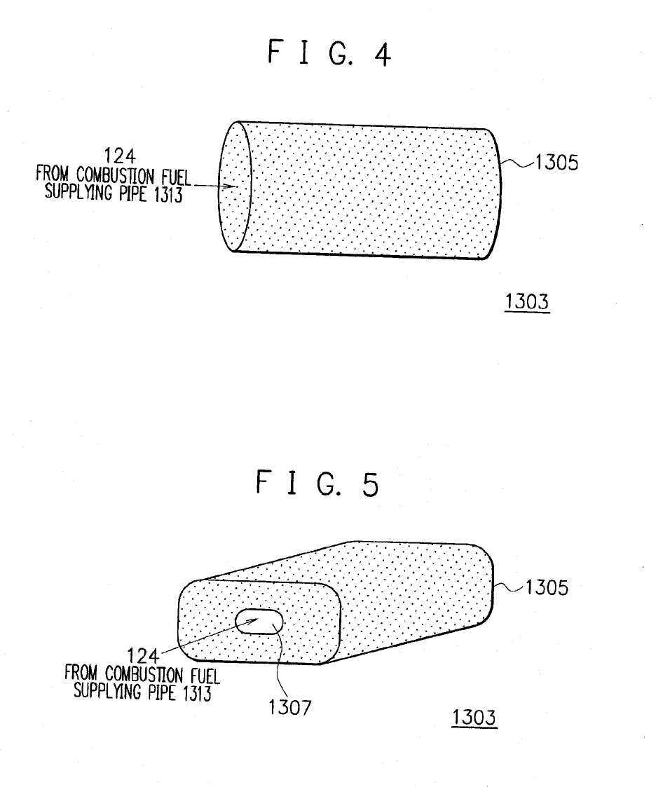

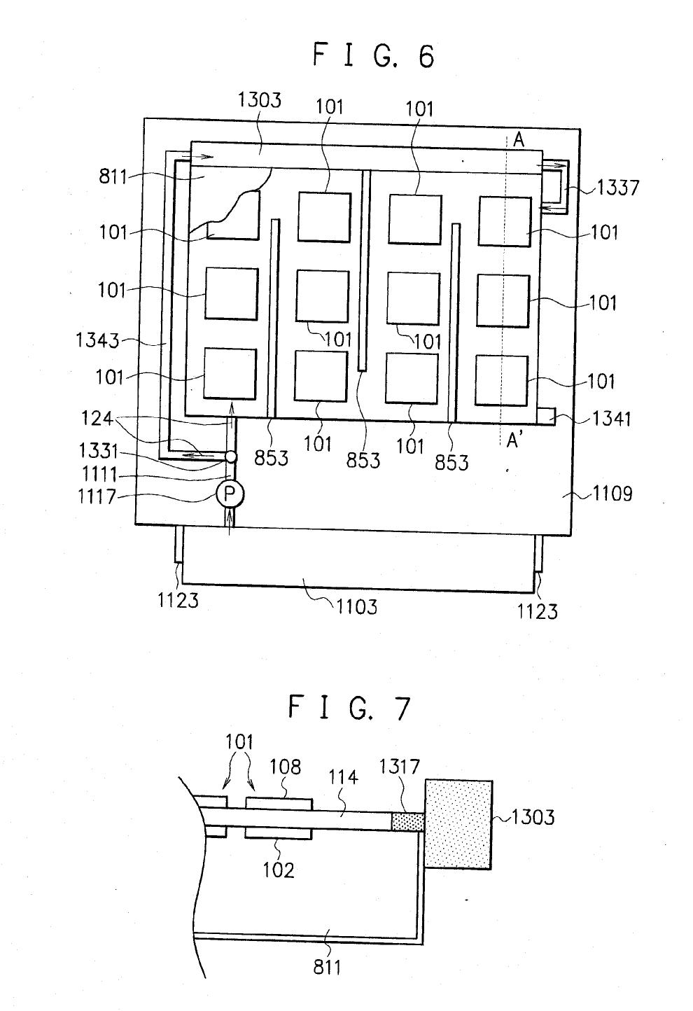

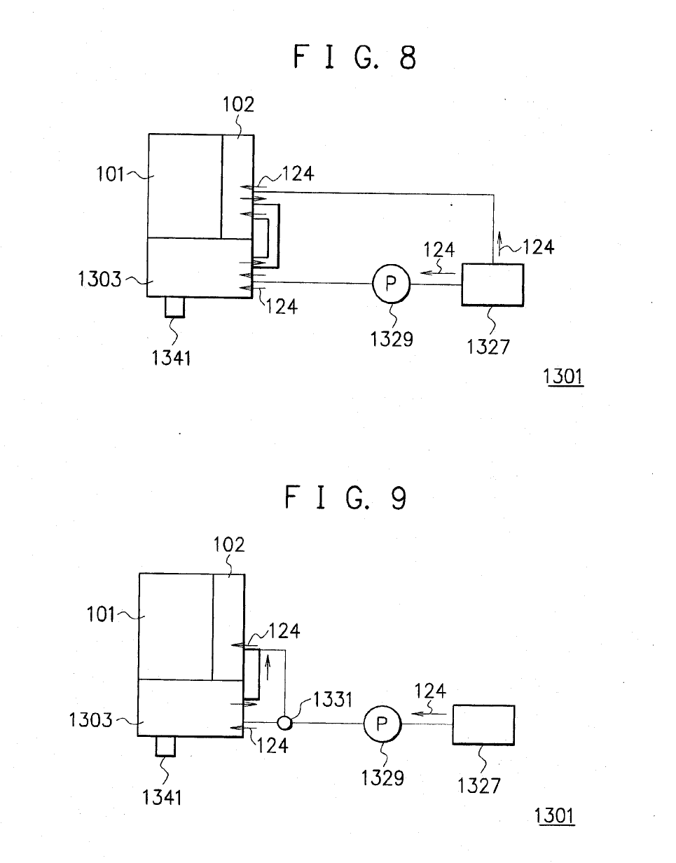

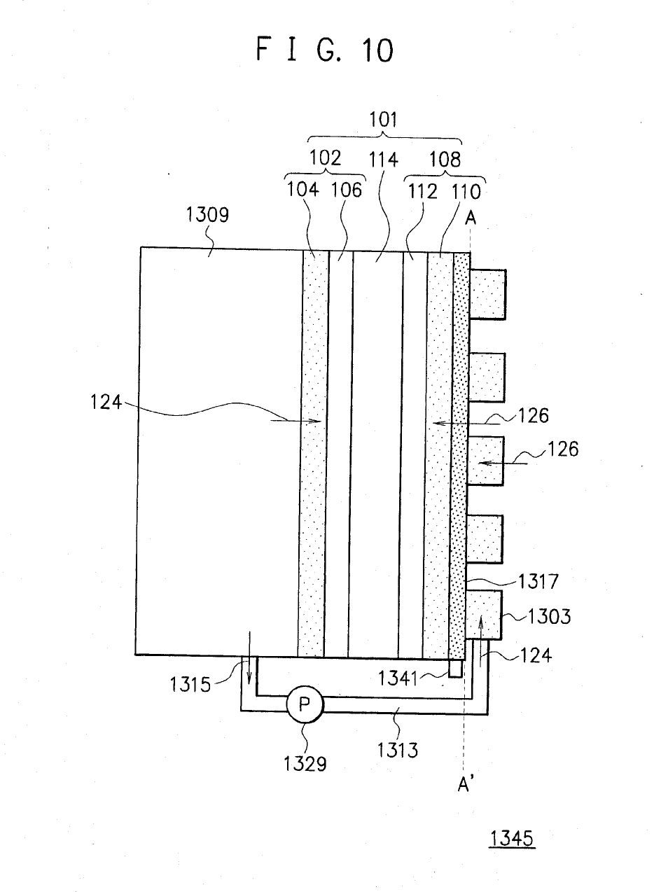

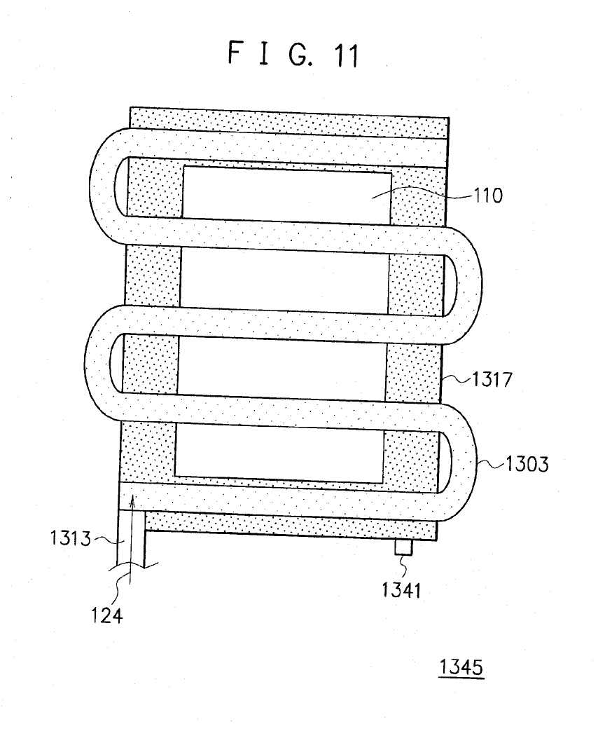

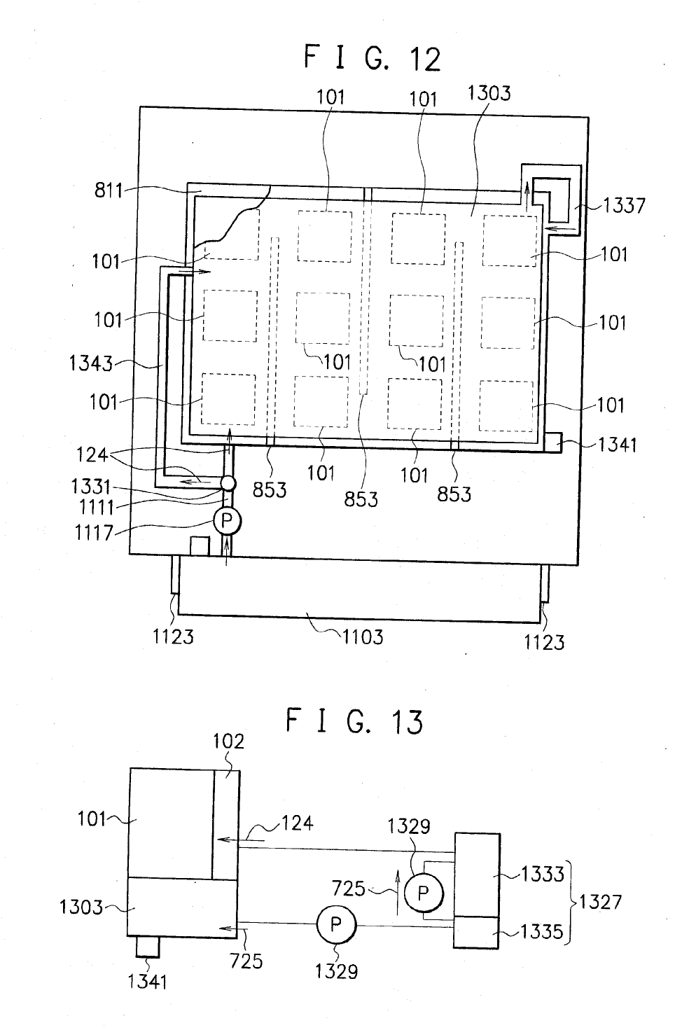

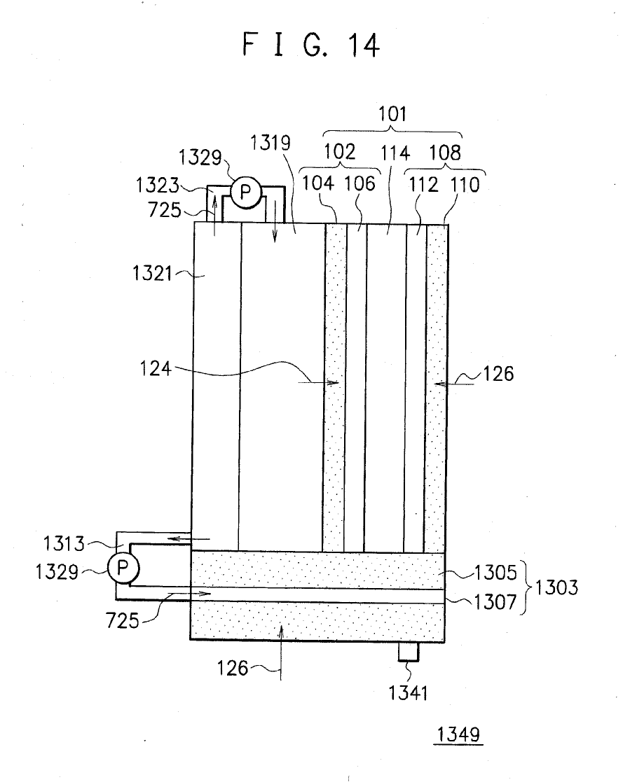

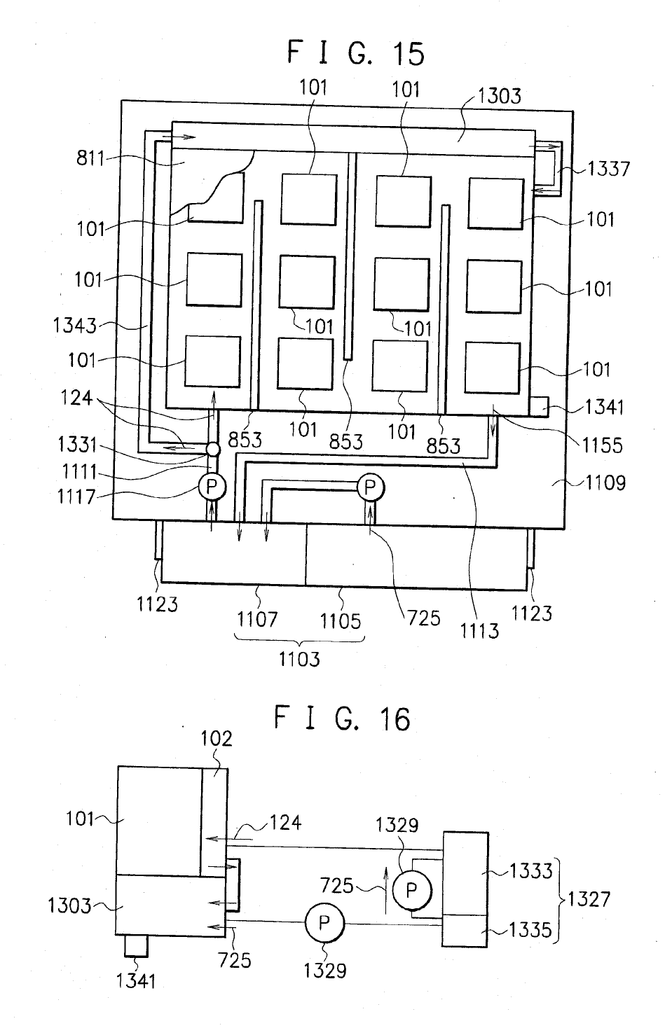

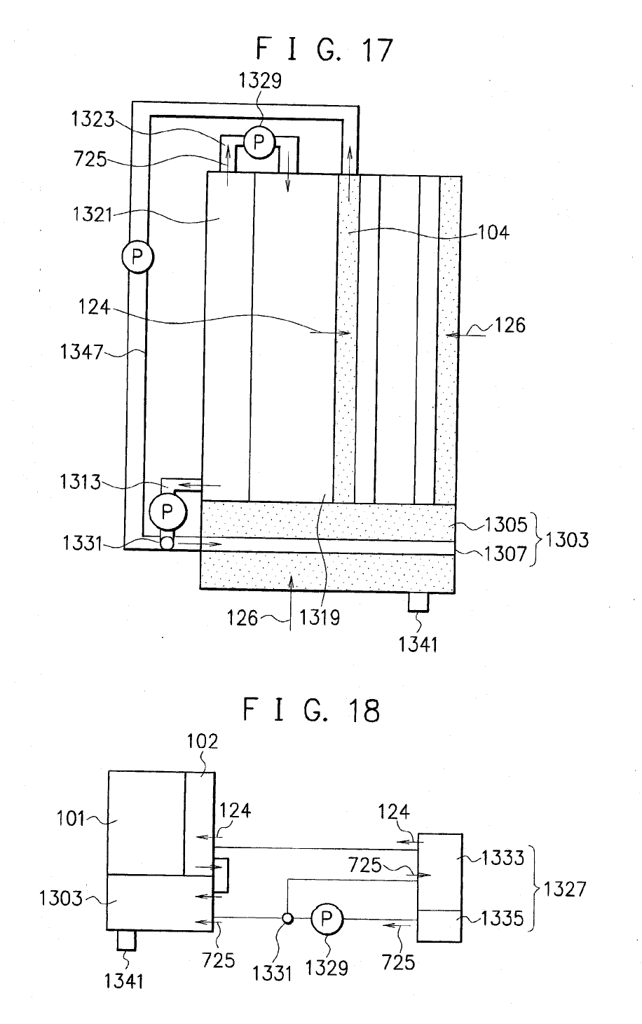

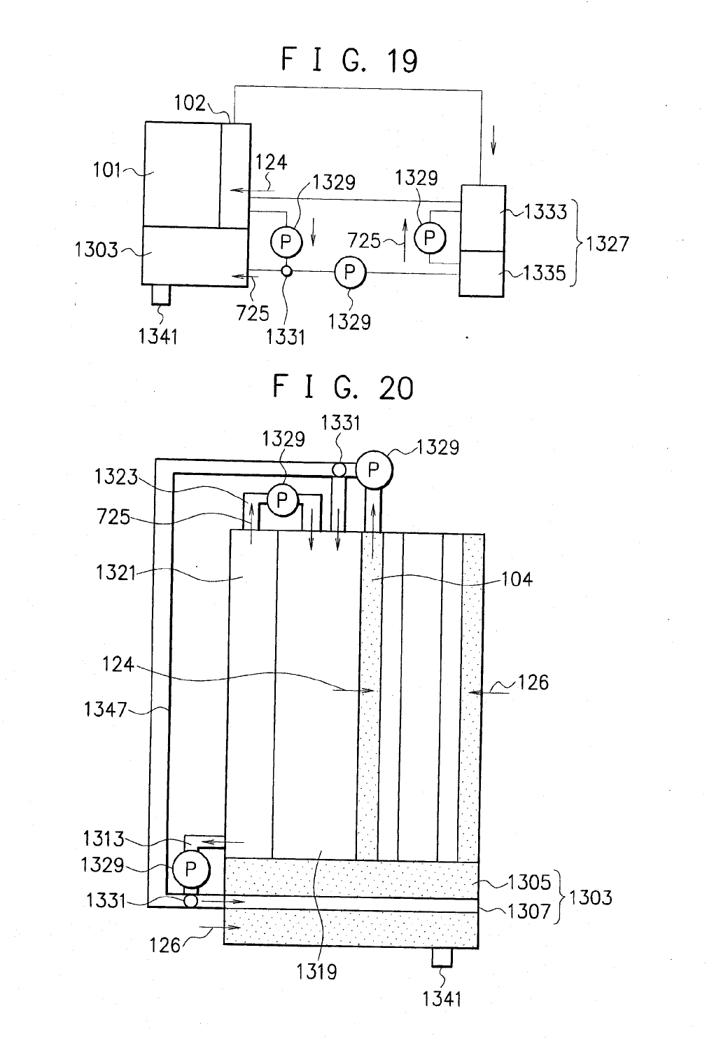

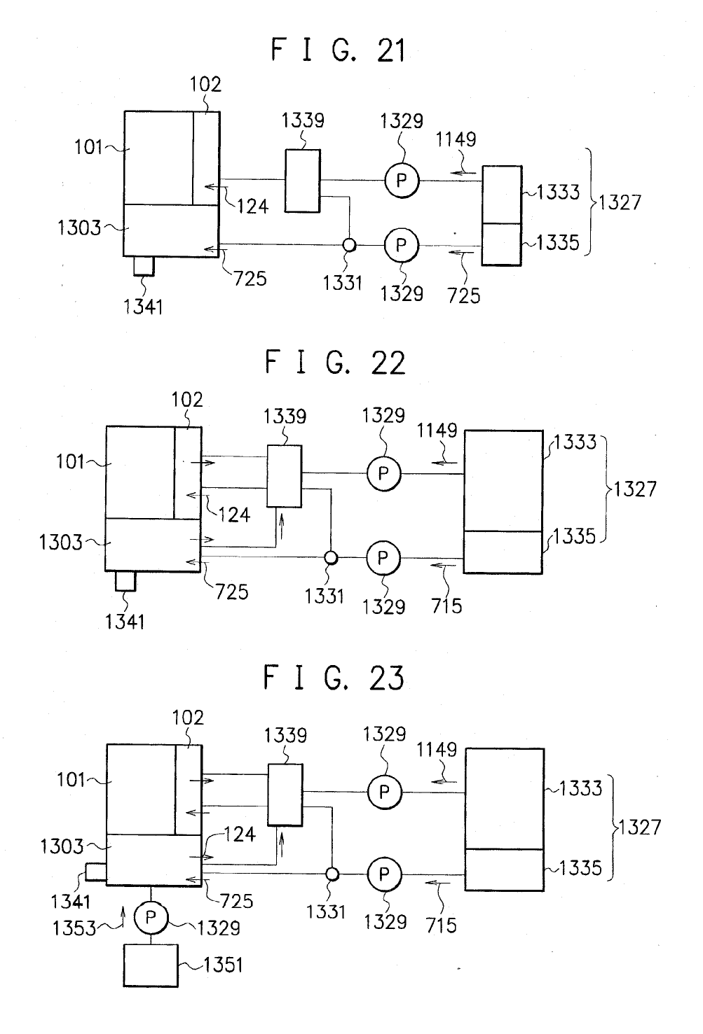

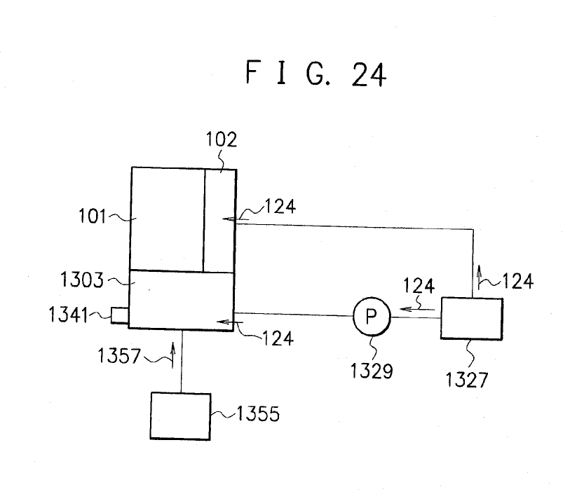

### DESCRIPTION OF REFERENCE NUMERALS

101 Unit Cell Structure
102 Fuel Electrode
104 Substrate
106 Catalyst Layer of Fuel Electrode
108 Oxidizer Electrode
110 Substrate
112 Catalyst Layer of Oxidizer Electrode
114 Solid Electrolyte Membrane
124 Fuel
126 Oxidizer
725 High-concentration Fuel
811 Fuel Container
853 Partition plate
1103 Fuel Cartridge
1105 High-concentration Fuel Tank
1107 Mixing Tank
1109 Fuel Cell Body
1111 Fuel Discharging Pipe
1113 Fuel Recovering Pipe
1117 Pump
1123 Connector
1149 Low-concentration Fuel
1155 Recovery Fuel
1301 Fuel Cell
1303 Combustion Unit
1305 Combustion Catalyst Retention Unit
1307 Combustion Fuel Passage
1309 Fuel Tank
1311 Fuel Cell
1313 Combustion Fuel Supplying Pipe
1315 Combustion Fuel Discharging Exit
1317 Heat Transfer Plate
1319 Mixing Tank
1321 High-concentration Fuel Tank
1323 High-concentration Fuel Supplying Pipe
1327 Fuel Tank
1329 Pump
1331 Flow Control Valve
1333 Low-concentration Fuel Tank
1337 Fuel Discharging Pipe
1339 Mixing Tank
1341 Thermometer
1343 Combustion Fuel Supplying Pipe
1345 Fuel Cell
1347 Fuel Recovering Pipe
1349 Fuel Cell
1351 Cooling Water Tank
1353 Cooling Water
1355 Oxidizer Retention Unit
1357 Oxidizer

1. A fuel cell comprising:
a unit cell that includes a solid electrolyte membrane, a fuel electrode and an oxidizer electrode disposed on the solid electrolyte membrane;
a heater for heating the unit cell; and
a fuel supplying system for supplying fuel to the fuel electrode,
wherein the heater is in contact with the unit cell,
part of the fuel is supplied from the fuel supplying system to the heater and
heat generated when the fuel supplied to the heater is combusted by the heater is conducted to the unit cell so that the unit cell is heated.

2. The fuel cell according to claim 1,
wherein the heater comprises a heating element and a heat conductor in contact with the heating element.

3. The fuel cell according to claim 1,
wherein the heater includes a heating catalyst used for combusting the fuel.

4. The fuel cell according to claim 1,
wherein the heater is in contact with the oxidizer electrode.

5. The fuel cell according to claim 1,
wherein liquid fuel is supplied directly to the fuel electrode.

6. The fuel cell according to claim 1, further comprising:
a plurality of unit cells;
a plurality of first electrodes that are provided on one side of the solid electrolyte membrane; and
a plurality of second electrodes that are provided on the other side of the solid electrolyte membrane, where one second electrode is disposed opposite to one first electrode,
wherein a unit cell is composed of a pair of a first electrode and a second electrode opposed to each other, and a solid electrolyte membrane, and
the heater heats a plurality of the unit cells.

7. The fuel cell according to claim 6, further comprising:
a temperature sensor for measuring a heating temperature in the heater or a temperature of the fuel cell; and
a controller for controlling supply of fuel from the fuel supplying system to the heater based on the temperature measured by the temperature sensor.

8. The fuel cell according to claim 6,
wherein the heater is in contact with the solid electrolyte membrane.

9. The fuel cell according to claim 6,
wherein the heater is in contact with a plurality of the first electrodes.

10. The fuel cell according to claim 1, further comprising:
a fuel recoverer for recovering the fuel having passed through the fuel electrode into the heater.

11. The fuel cell according to claim 6,
wherein the fuel supplying system comprises a high-concentration fuel supplier for supplying fuel having concentration higher than that of fuel supplied to the fuel electrode to the heater.

12. The fuel cell according to claim 11, further comprising:
a fuel mixer for mixing high-concentration fuel supplied from the high-concentration fuel supplier and fuel supplied to the fuel electrode.

13. The fuel cell according to claim 6, further comprising:
a controller for controlling the heating temperature of the heater by cooling water.

14. The fuel cell according to claim 6, further comprising:
an oxidizer supplier for supplying an oxidizer to the heater.
